(19) United States
(12) Patent Application Publication
(10) Pub. No.: US 2026/0249379 A1
(43) Pub. Date: Aug. 27, 2026

(54) WELD SPOT NUMBER MANAGEMENT DEVICE

(71) Applicant: FANUC CORPORATION, Yamanashi (JP)

(72) Inventor: Takahiro AOYAGI, Yamanashi (JP)

(21) Appl. No.: 18/857,183

(22) PCT Filed: Apr. 22, 2022
(86) PCT No.: PCT/JP2022/018550

§ 371 Date: Oct. 16, 2024

(51) Int. Cl. B23K 11/36; B23K 11/11; B23K 31/12

(52) U.S. Cl. CPC B23K 11/36; B23K 11/11; B23K 31/125

(57) ABSTRACT

A purpose is to reduce a burden of a confirmation operation of a number of weld spots to a workpiece by a worker. A weld spot number management device 10 according to one aspect of the present disclosure includes a reception unit 15 that receives, from a plurality of welding robots, welding information that is generated for each weld spot with respect to components to be welded by a plurality of welding robots 30, and includes component numbers that individually identify each of the components, program information showing programs used in welding of the components, and time and date information, a storage unit 14 that adds robot information identifying the respective welding robots to the welding information and stores the welding information, an aggregation unit 18 that aggregates a total number of weld spots of each of the components based on the welding information, and a display unit 13 that displays a list of the total numbers of weld spots that are aggregated.

### RELATED APPLICATIONS

The present application is a National Phase of International Application No. PCT/JP2022/018550 filed Apr. 22, 2022.

### TECHNICAL FIELD

This disclosure relates generally to a weld spot number management device.

### BACKGROUND ART

In recent years, use of a welding robot equipped with a spot-welding gun to weld a vehicle body or the like has increased. In the welding operation by a spot-welding gun, two workpieces to be welded are sandwiched by a movable electrode tip and a fixed electrode tip, and electricity is passed through the two workpieces in a state where a predetermined pressing force is applied thereto, whereby the two workpieces can be welded. In order to suppress degradation of quality of the welding operation by a welding robot, it is important to find a welding failure, a weld spot omission and the like. As a technique for detecting a welding failure, for example, a technique for determining an abnormality of a weld location based on data acquired by an external sensor is known (for example, Patent Literature 1). A worker can grasp the welding failure by using the technique of detecting a welding failure like this. On the other hand, for example, as for the weld spot omission, welding data of each weld spot to a workpiece collected from the welding robot are displayed on a display device according to a time series, and the worker counts the number of welding data, and thereby confirms the number of weld spots to the workpiece.

However, work of counting the number of welding data to confirm the number of weld spots to the workpiece has a large burden on the worker and a weld spot omission may be overlooked due to a counting mistake or the like.

### CITATION LIST

### Patent Literature

Patent Literature 1: Japanese Patent Laid-Open No. 2021-10925

### BRIEF DESCRIPTION OF THE VIEWS OF THE DRAWING

FIG. 1 is a view showing a welding system including a weld spot number management device according to an embodiment.

FIG. 2 is a functional block diagram of the weld spot number management device in FIG. 1.

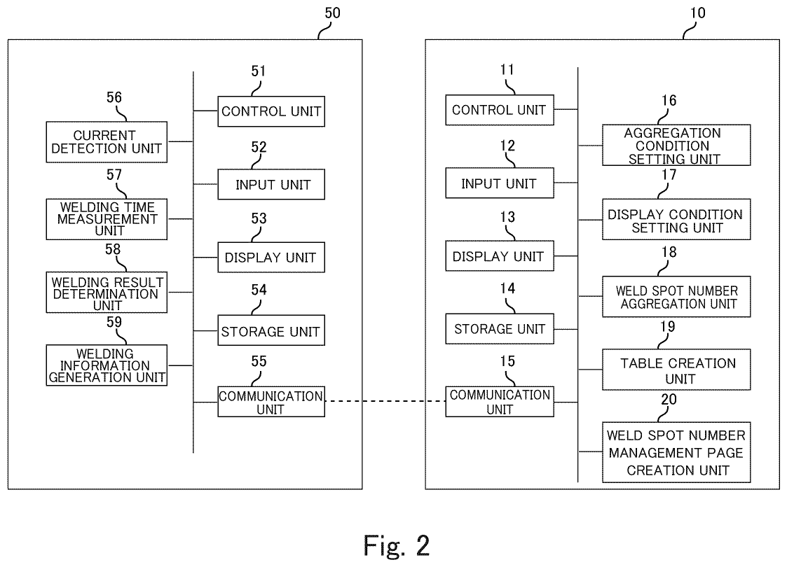

FIG. 3 is a diagram showing an example of a weld spot number management page that is provided by the weld spot number management device in FIG. 1.

FIG. 4 is a diagram showing another example of the weld spot number management page that is provided by the weld spot number management device in FIG. 1.

### DETAILED DESCRIPTION OF THE INVENTION

A weld spot number management device according to one aspect of the present disclosure includes a reception unit that receives, from a plurality of welding robots, welding information that is generated for each weld spot with respect to components to be welded by the plurality of welding robots, and includes component numbers that each of individually identify the components, program information showing programs that are used in welding of the components, and time and date information, a storage unit that adds robot information identifying each of the welding robots to the welding information and stores the welding information, an aggregation unit that aggregates a total number of weld spots of each of the components based on the welding information, and a display unit that displays a list of the aggregated total number of weld spots.

Hereinafter, a weld spot number management device according to the present embodiment will be described with reference to the drawings. In the following description, the same reference numerals denote components having substantially identical functions and structures, and the repeated description thereof is made only when necessary.

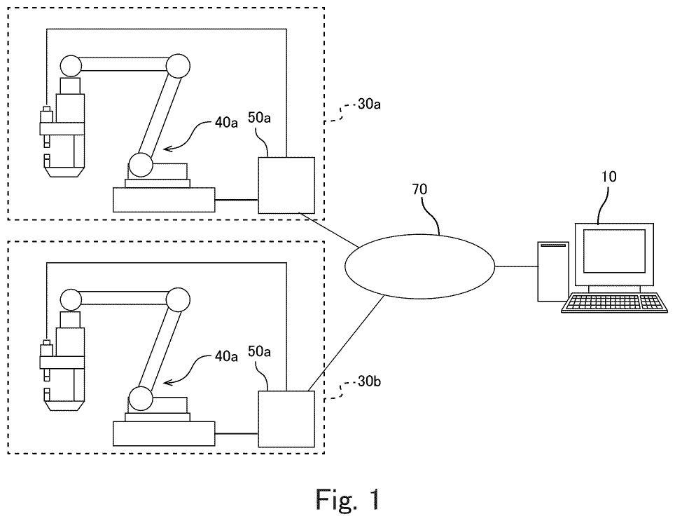

As shown in FIG. 1, a weld spot number management device 10 according to the present embodiment is connected to a plurality of welding robots 30 (30a, 30b) via a network 70 such as a LAN. The welding robots 30 (30a, 30b) are formed of welding robot bodies 40 (40a, 40b), and welding robot control devices 50 (50a, 50b) that control the welding robot bodies 40 (40a, 40b). The welding robot body 40 is provided by an articulated arm mechanism equipped with a spot-welding gun. In the present embodiment, the welding robot control device 50 is provided as a single device having a function of controlling the articulated arm mechanism and a function of controlling the spot-welding gun. However, the welding robot control device 50 may have a configuration in which a robot control device that controls the articulated arm mechanism and the welding gun control device that controls the spot-welding gun are individually provided respectively, and these devices are connected to be communicable with each other.

The welding robot control device 50 has a processor configured by a CPU, GPU, and the like, a RAM that functions as a main memory, a work area, and the like of the processor, and a storage device in which various programs, various kinds of setting information and the like are stored.

In the storage device, a welding program for causing the welding robot 30 to execute a predetermined welding operation is stored. The welding program is prepared for each type of workpiece (component) to be welded. For example, the welding program is provided in a text format, and an operation instruction is described in each line. The operation instruction includes a movement instruction to a weld spot, a welding instruction, a wait instruction, and the like. The welding instruction includes a pressing force command, a welding current command, and the like.

As a result of the welding program being executed by the processor, the welding robot control device 50 functions as a control unit 51, an input unit 52, a display unit 53, a storage unit 54, a communication unit 55, a current detection unit 56, a welding time measurement unit 57, a welding result determination unit 58, and a welding information generation unit 59.

The control unit 51 controls the welding robot according to the welding program.

The input unit 52 inputs a user operation via an input device such as a keyboard, a mouse, and a teaching operation panel to the welding robot control device 50. Specifically, setting information necessary to cause the welding robot to perform a predetermined welding operation is inputted to the welding robot control device 50 by the user operation. The setting information includes program information specifying a welding program used for welding, and welding gun information specifying a spot-welding gun to be used. As a matter of course, a configuration may be adopted, in which an information processing terminal such as a smartphone, a tablet, and a PC is connected to the welding robot control device 50, and the above-described setting information is inputted to the welding robot control device 50 by the user operation via the information processing terminal.

The display unit 53 displays a screen that receives an input of the setting information required for causing the welding robot 30 to perform a predetermined welding operation.

The current detection unit 56 detects a value of a current (hereinafter, referred to as a gun shaft current value) that flows when electricity is passed between a fixed electrode tip and a movable electrode tip of the spot-welding gun. For detection of the gun shaft current value, an existing method can be used, and for example, a current sensor or the like can be used. Data concerning the gun shaft current value detected by the current detection unit 56 are sent to the welding information generation unit 59.

The welding time measurement unit 57 measures a time in which electricity is passed between the fixed electrode tip and the movable electrode tip of the spot-welding gun as a welding time. Data concerning the welding time measured by the welding time measurement unit 57 are sent to the welding information generation unit 59.

The welding result determination unit 58 determines whether or not the welding result is successful. For example, the welding result determination unit 58 determines whether the welding result is “success”, “failure”, “pseudo welding”, “welding retry” or “welding invalid” for each weld spot. Data concerning the determination result by the welding result determination unit 58 are sent to the welding information generation unit 59.

The welding information generation unit 59 generates welding information for each weld spot. Specifically, the welding information generation unit 59 organizes information relating to welding of a weld spot as a data body, and generates welding information in which incidental information is associated with the data body. The information relating to welding includes data concerning a gun shaft current value, data concerning a welding time, and data concerning a welding result. The incidental information includes time and date information, robot information, welding gun information, component information, weld spot information, and program information. The time and date information includes welding time and date of a weld spot (welding start time and date). The robot information includes a robot name for identifying the welding robot 30 that is used. The welding gun information includes a gun number for identifying the welding gun that are used. The component information includes a component number for individually identifying each component to be welded. The component information may include a component type ID for individually identifying the type of the component to be welded. The weld spot information includes a weld spot ID for individually identifying each weld spot to be welded. The program information includes a program name for identifying a welding program that is used.

Of the incidental information, the robot name, the gun number, the component type ID and the program name are inputted by a user operation via the input unit 52. The component number is given to each of components to be welded as a serial number after a series of welding operations is started. The weld spot ID corresponds to an order of the weld spot that is defined by the welding program.

The storage unit 54 stores welding information of each weld spot that is generated by the welding information generation unit 59.

The communication unit 55 controls transmission and reception of various kinds of information to and from the weld spot number management device 10. By processing of the communication unit 55, the welding robot control device 50 transmits welding information corresponding to one weld spot to the weld spot number management device 10 each time welding for one weld spot is finished. As a matter of course, the welding robot control device 50 may collectively transmit the welding information corresponding to all the weld spots to the weld spot number management device 10 at timing when welding for all the weld spots to the component to be welded is completed.

The weld spot number management device 10 includes hardware similar to that of an ordinary PC such as a processor, a ROM, a RAM, a storage device, and an input/output interface. In the storage device, the weld spot number management program is stored. As a result of the weld spot number management program being executed by the processor, the weld spot number management device 10 functions as a control unit 11, an input unit 12, a display unit 13, a storage unit 14, a communication unit 15, an aggregation condition setting unit 16, a display condition setting unit 17, a weld spot number aggregation unit 18, a table creation unit 19, and a weld spot number management page creation unit 20.

The control unit 11 generally controls respective units that configure the weld spot number management device 10.

The input unit 12 inputs a user operation via an input device such as a keyboard, a mouse, and a teaching operation panel to the weld spot number management device 10. Specifically, according to the user operation, display conditions are inputted to the weld spot number management device 10 according to the user operation.

The storage unit 14 stores the welding information received via the communication unit 15. Further, the storage unit 14 stores initial setting data of the aggregation conditions.

The communication unit 15 performs transmission and reception of various kinds of information to and from the welding robot control device 50. By processing of the communication unit 15, the weld spot number management device 10 sequentially receives the welding information from the welding robot control device 50.

The aggregation condition setting unit 16 sets the aggregation conditions. The aggregation condition is a condition for aggregating the number of weld spots. As the aggregation conditions, a component number, a robot name, and a program name are initially set.

The display condition setting unit 17 sets a display condition according to a user operation via the input unit 12. The display condition is a condition for determining a display object of an aggregation result of the number of weld spots, and the setting items include a component number, a component type, time and a date, a robot name, a program name and the like. For example, if the welding information generated at the same time and date is desired to be confirmed, the time and date can be set. If the number of weld spots of the component welded by a specific robot at the same time and date is desired to be confirmed, the robot name can be set with the time and date. If the total number of weld spots to a plurality of components of the same type is desired to be confirmed, the component type ID can be set.

The weld spot number aggregation unit 18 aggregates total numbers of weld spots and numbers of successful weld spots, according to the aggregation conditions set by the aggregation condition setting unit 16. The total number of weld spots corresponds to a total number of weld spots that are welded of each component to be welded. Accordingly, the total number of weld spots is a number that includes not only the number of weld spots successfully welded but also the number of weld spots failed in welding and the like. The number of successful weld spots corresponds to the number of weld spots where the welding results are “success” among the weld spots welded for each component to be welded. For example, the weld spot number aggregation unit 18 extracts, from the welding information stored in the storage unit 14 by the welding information management unit, welding information in which component numbers, robot names, and program names correspond to one another as the aggregation conditions set by the aggregation condition setting unit 16. Then, the weld spot number aggregation unit 18 aggregates the number of pieces of extracted welding information as the total number of weld spots, and aggregates the number of pieces of welding information in which the welding results included in the pieces of welding information are “success” among the pieces of extracted welding information as the number of successful weld spots.

The table creation unit 19 creates an aggregation table in which an aggregation result of the number of weld spots of each component is collected according to the display condition set by the display condition setting unit 17. One record of the aggregation table includes a plurality of items. The plurality of items include start time and date, end time and date, a component number, a robot name, a program name, a gun number, a number of successful weld spots, and a total number of weld spots. The start time and date correspond to welding time and date of an initial weld spot of a component. The end time and date correspond to the welding time and date of a last weld spot of the component. As a matter of course, the start time and date and the end time and date in the aggregation table may be start time and date and end time and date of a program. Among the plurality of items, the start time and date, the end time and date, the component number, the robot name, the program name, and the gun number are data included in the welding information. The number of successful weld spots and the total number of weld spots are data provided by the weld spot number aggregation unit 18.

The table creation unit 19 creates a list in which welding information of the aggregation source with the number of weld spots of each component being aggregated is listed. One record of the list includes a plurality of items. The plurality of items include welding time and date, a component number, a robot name, a program name, a program line number, a welding ID, a welding result, and a welding time. The program line number indicates a line number in which a command instructing welding of a weld spot is described in the program described in a text format. The welding ID is an ID for specifying the weld spot in the component, and corresponds to, for example, an order of welding.

The weld spot number management page creation unit 20 generates data of the weld spot number management page including the list concerning the number of weld spots of each component created by the table creation unit 19. The weld spot number management page created by the weld spot number management page creation unit 20 is displayed in the display unit 13.

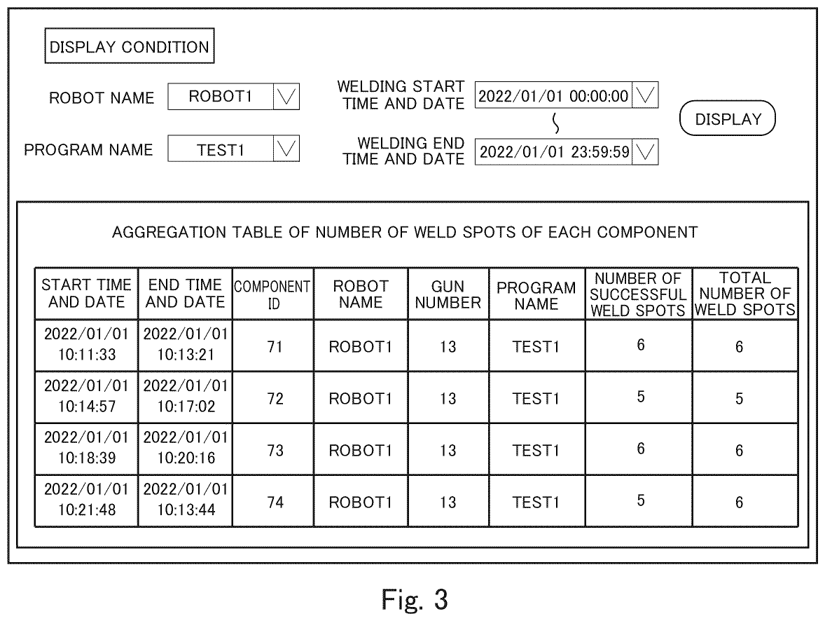

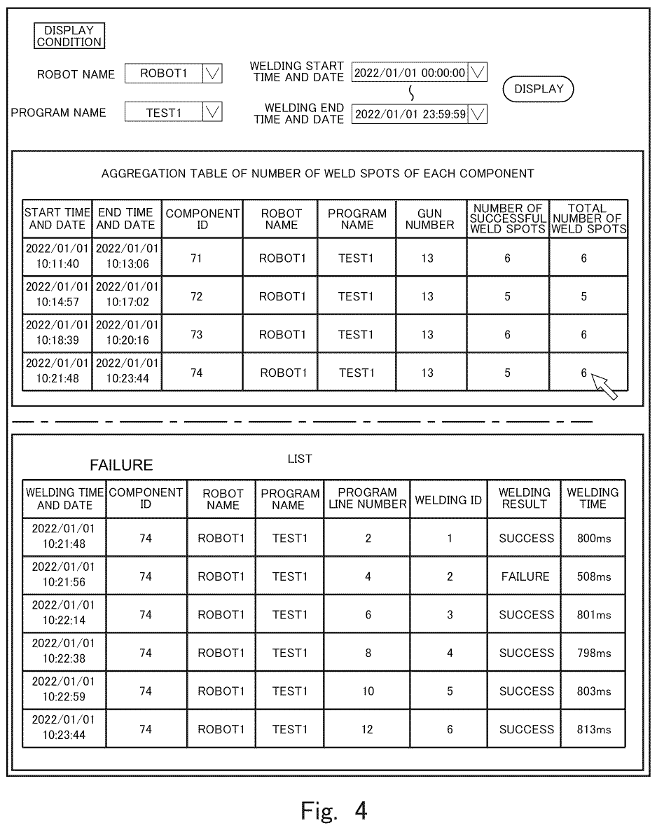

Hereinafter, the weld spot number management page created by the weld spot number management page creation unit 20 will be described with reference to FIG. 3 and FIG. 4. As shown in FIG. 3, the weld spot number management page includes a plurality of input boxes for a user to input the display conditions, a display button for setting the display conditions, and a first display area that displays a list of the number of weld spots of each component. As shown in FIG. 3, the plurality of input boxes include an input box for inputting a robot name, an input box for inputting a program name, and input boxes for inputting welding start time and date, and welding end time and date. Here, by a user operation, the robot name “ROBOT1”, the program name “TEST1”, the welding start time and date “2022/01/01 00:00:00”, and the welding end time and date “2022/01/01 23:59:59” are inputted as the display conditions. When the display button is clicked by the user, the display conditions inputted by the user are set by the display condition setting unit, the aggregation table of the number of weld spots of each component is created by the table creation unit 19 according to the display conditions that are set, and the created aggregation table is displayed in the first display area.

As shown in FIG. 4, when one record is selected by the user operation on the aggregation table of the number of weld spots of each component displayed in the first display area, a second display area is provided below the first display area. In the second display area, a list in which the welding information of the aggregation source with the number of weld spots of each component being aggregated is listed is displayed. Here, a record of the component number “74” is selected by the user operation on the list of the number of weld spots of each component displayed in the first display area, and in the second display area, the list created by the table creation unit 19 based on the welding information which is an aggregation source for aggregating the total number of weld spots of the component number “74” is displayed in the second display area.

According to the weld spot number management device 10 according to the present embodiment, effects as follows are exhibited. That is, the weld spot number management device 10 can automatically aggregate a total number of weld spots to a component to be welded for each component to be welded, each welding robot 30 that is used, and each welding program that is used, based on welding information received from each of a plurality of welding robots 30, and can display the aggregation results.

For example, as shown in FIG. 3, the weld spot number management device 10 can notify the user of the total number of weld spots and the number of successful weld spots of each of the components, via the aggregation table displayed on the weld spot number management page. In the aggregation table shown in FIG. 3, the total numbers of weld spots of the component numbers “71”, “73”, and “74” are “6”, while the total number of weld spots of the component number “72” is “5”. This means that a weld spot omission has occurred in either one of the groups. The user browses the aggregation table shown in FIG. 3, confirms the total number of weld spots for each component, and thereby can easily find out the weld spot omission. In this way, aggregating the total number of weld spots of each component, and displaying it contribute to improvement of welding quality of the component to be welded. Note that on the weld spot number management page, information concerning the total number of weld spots to be welded based on the welding program may be displayed. Thereby, it is possible to easily grasp in which group the weld spot omission occurs when there are two groups different from each other in the total number of weld spots.

Further, in the aggregation table shown in FIG. 3, the total number of weld spots of the component number “74” is “6”, and the number of successful weld spots is “5”. This means that welding to any one weld location of the six weld locations of the component has failed. The user browses the aggregation table shown in FIG. 3, confirms the total number of weld spots and the successful weld spots of the same component, and thereby can easily finds out whether or not welding of all the weld spots has succeeded. In this way, aggregating the total number of weld spots and the number of successful weld spots of the same component, and displaying them also contribute to improvement of welding quality of the component to be welded.

Furthermore, as shown in FIG. 4, by selecting a record having a failed weld spot in the aggregation table, and confirming the welding information of the aggregation source, it is possible to grasp in which weld spot welding has failed. Further, in the aggregation table, by selecting the record suspected to have a weld spot omission, and confirming the welding information of the aggregation source, it is possible to instantly grasp the weld spot where the weld spot omission has occurred. These also contribute to improvement of welding quality.

In the present embodiment, the component number, the robot name, and the program name are initially set as the aggregation conditions of the number of weld spots. Thereby, even if there are duplicate component numbers, the component can be identified by the robot name and the program name, and the number of weld spots of each of the components can be aggregated. However, the aggregation conditions that are initially set are not limited thereto. Assuming that there are no duplicate component numbers, only the component numbers may be initially set as the aggregation condition. As a matter of course, a plurality of types of aggregation conditions may be prepared as the initial conditions, and may be selected by the user. Further, the aggregation conditions may be set according to the user operation. For example, item candidates for setting the aggregation conditions include time and date, a component number, a component type ID, a robot name, a gun number, a program name, and a line number of the program. For example, by setting a range of the program line number together with the component number, the robot name, and the program name as the aggregation conditions, the total number of weld spots of each component can be divided into a plurality of numbers and displayed. For example, by setting the line numbers of the program as “1 to 20”, “21 to 40”, and “41 to 60”, a partial number of weld spots corresponding to the line number 1 to the line number 20 of the program, a partial number of weld spots corresponding to the line numbers 21 to 40 of the program, and a partial number of weld spots corresponding to the line numbers 41 to 60 of the program can be each aggregated for each component. Accordingly, when a weld spot omission is found, it is possible to easily identify which range of the program includes a process of causing the weld spot omission. This also contributes to improvement of welding quality.

Although in the present embodiment, the incidental information included in the welding information is described as being attached in the welding robot control device 50, at least a part of the incidental information may be attached in an information processing device other than the welding robot control device 50, for example, an upper device of a system. In this case, the data body generated by the welding robot control device 50 is sent to the information processing device, and in the information processing device, welding information in which the incidental information is added to the data body is generated and is sent to the weld spot number management device 10 from the information processing device. Further, at least part of the incidental information may be added in the weld spot number management device 10. For example, when receiving the welding information, the weld spot number management device 10 can identify the transmission source of the welding information, and add the robot information to the welding information.

In the present embodiment, the welding robot 30 is equipped with the spot-welding gun, and can execute spot welding, but the type of welding is not limited to this. For example, the welding robot 30 may be the one capable of arc welding.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A weld spot number management device that is connected to a plurality of welding robots, comprising:
a reception unit that receives, from the plurality of welding robots, welding information that is generated for each weld spot with respect to components to be welded by the plurality of welding robots, and includes robot information that individually identifies each of the welding robots, component numbers that individually identify each of the components, program information showing programs that are used in welding of the components, and time and date information;
an aggregation unit that aggregates a total number of weld spots of each of the components based on the welding information; and
a display unit that displays a list of the aggregated total number of weld spots.

2. The weld spot number management device according to claim 1, wherein the aggregation unit aggregates numbers of pieces of welding information in which the component number, the program information and the robot information correspond to one another, as the total number of weld spots.

3. The weld spot number management device according to claim 1, wherein
the welding information includes success and at least one of failure, pseudo welding, welding retry, and welding invalid as a welding result,
the aggregation unit aggregates the total number of weld spots of each of the components and a number of successful weld spots where the welding result of each of the components is successful, and
the display unit displays the total number of weld spots and the number of successful weld spots.

4. The weld spot number management device according to claim 1, wherein the display unit displays a list of the welding information of each weld spot of the component selected according to a user operation.
